(19) United States
(12) Patent Application Publication
(10) Pub. No.: US 2026/0167460 A1
(43) Pub. Date: Jun. 18, 2026

(54) ELEVATOR CAR CEILING ACCESS SYSTEM

(71) Applicant: Otis Elevator Company, Farmington, CT (US)

(72) Inventors: Vinothkumar R, Banglaore (IN); Venkatesh R, Banglaore (IN); Vivek T, Banglaore (IN); Jagadeesh Mandi, Banglaore (IN)

(21) Appl. No.: 19/419,402

(22) Filed: Dec. 15, 2025

(30) Foreign Application Priority Data
Dec. 16, 2024 (IN) 202411099637

(51) Int. Cl. B66B 11/02

(52) U.S. Cl. CPC B66B 11/0246

(57) ABSTRACT

Elevator ceiling access systems include a ceiling panel of an elevator car and a platform assembly movably attached to the ceiling panel. The platform assembly includes a platform and a ladder that is deployable from the platform. The platform assembly is deployable from a stowed state to a deployed state, and in the deployed state a position of the platform is adjustable within the elevator car and the platform is supported on one side by the ladder and on an opposite side by the ceiling panel.

### FOREIGN PRIORITY

This application claims priority to India Patent Application No. 202411099637, filed Dec. 16, 2024, and all the benefits accruing therefrom under 35 U.S.C. § 119, the contents of which in its entirety are herein incorporated by reference.

### BACKGROUND

The subject matter disclosed herein generally relates to elevator systems and, more particularly, to elevator access systems and in particular to elevator car ceiling access systems.

Elevator systems require maintenance to be performed on the various components thereof, with some such components located exterior from the interior cab of the elevator car. Such components may be arranged on an exterior structure of the elevator car and/or located within an elevator shaft. To perform maintenance on such components, technicians may be required to gain access to the exterior of the elevator car. In some elevator systems, the elevator cars may be provided with a ceiling access panel or similar opening to allow for a technician to access the top of an elevator car from the inside of the elevator car. The ceiling access panels are manually operable and can be difficult to access depending on the size or dimensions of the elevator car. Accordingly, improved access to and operation of ceiling access panels of elevator cars may be advantageous.

### SUMMARY

According to some embodiments, elevator ceiling access systems are provided. The elevator ceiling access systems include a ceiling panel of an elevator car and a platform assembly movably attached to the ceiling panel. The platform assembly includes a platform and a ladder that is deployable from the platform. The platform assembly is deployable from a stowed state to a deployed state, wherein in the deployed state a position of the platform is adjustable within the elevator car and the platform is supported on one side by the ladder and on an opposite side by the ceiling panel.

In addition to one or more of the features described above, or as an alternative, further embodiments of the elevator ceiling access systems may include a ceiling frame, wherein the ceiling panel is pivotably mounted to the ceiling frame.

In addition to one or more of the features described above, or as an alternative, further embodiments of the elevator ceiling access systems may include a locking element configured to releasably secure the ceiling panel to the ceiling frame.

In addition to one or more of the features described above, or as an alternative, further embodiments of the elevator ceiling access systems may include at least one biasing element configured to support and connect the ceiling panel to the ceiling frame.

In addition to one or more of the features described above, or as an alternative, further embodiments of the elevator ceiling access systems may include that the ceiling panel is hingedly or pivotably attached to the ceiling frame by one or more hinge elements.

In addition to one or more of the features described above, or as an alternative, further embodiments of the elevator ceiling access systems may include at least one mounting rail configured as part of or attached to the ceiling panel, wherein the platform assembly is supported on the at least one mounting rail in the stowed state and in the deployed state.

In addition to one or more of the features described above, or as an alternative, further embodiments of the elevator ceiling access systems may include that the platform assembly comprises at least one platform rail that pivotably connects to the at least one mounting rail.

In addition to one or more of the features described above, or as an alternative, further embodiments of the elevator ceiling access systems may include that the at least one mounting rail is pivotably connected to the platform at one end of the at least one mounting rail and an opposite end of the at least one mounting rail is slidingly mounted on a sliding rail.

In addition to one or more of the features described above, or as an alternative, further embodiments of the elevator ceiling access systems may include a support bracket arranged on the ceiling panel, wherein the at least one mounting rail is configured to selectively attach to the support bracket.

In addition to one or more of the features described above, or as an alternative, further embodiments of the elevator ceiling access systems may include that the platform assembly further comprises a safety rail system that is configured to attach to the platform.

In addition to one or more of the features described above, or as an alternative, further embodiments of the elevator ceiling access systems may include that the safety rail system comprises collapsible elements configured to be stored on the platform assembly when the platform assembly is in the stowed state.

In addition to one or more of the features described above, or as an alternative, further embodiments of the elevator ceiling access systems may include that the ladder is hingedly attached to the platform.

In addition to one or more of the features described above, or as an alternative, further embodiments of the elevator ceiling access systems may include that the platform is adjustable in a first direction along one or more platform rails and adjustable in a second direction along a sliding rail, wherein the first direction and the second direction are normal to each other.

In addition to one or more of the features described above, or as an alternative, further embodiments of the elevator ceiling access systems may include that the platform assembly is configured to be unfolded from the stowed state to the deployed state from the ceiling panel.

In addition to one or more of the features described above, or as an alternative, further embodiments of the elevator ceiling access systems may include that the ladder is releasably secured to the platform by a ladder lock.

In addition to one or more of the features described above, or as an alternative, further embodiments of the elevator ceiling access systems may include that the platform assembly is releasably secured to the ceiling panel by at least one platform lock.

In addition to one or more of the features described above, or as an alternative, further embodiments of the elevator ceiling access systems may include that the ladder is a collapsible ladder.

In addition to one or more of the features described above, or as an alternative, further embodiments of the elevator ceiling access systems may include that the ladder is a telescoping ladder.

According to some embodiments, elevator systems are provided. The elevator systems include an elevator car having a floor, a ceiling, and side walls and defining an interior of the elevator car, a ceiling frame defining an opening in the ceiling of the elevator car, a ceiling panel arranged to cover the opening and configured to be opened to expose the opening, and a platform assembly movably attached to the ceiling panel. The platform assembly includes a platform and a ladder that is deployable from the platform, wherein the platform assembly is deployable from a stowed state to a deployed state, wherein in the deployed state a position of the platform is adjustable within the elevator car and the platform is supported on one side by the ladder and on an opposite side by the ceiling panel.

In addition to one or more of the features described above, or as an alternative, further embodiments of the elevator systems may include that the elevator car is an overslung elevator car.

In addition to one or more of the features described above, or as an alternative, further embodiments of the elevator systems may include that the platform, when in the deployed state, is adjustable in a car width direction and a car depth direction while being supported on one or more mounting rails.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing door of an elevator system that may employ various embodiments of the present disclosure;

FIG. 3 is a schematic illustration of an elevator car having an elevator ceiling panel access system in accordance with an embodiment of the present disclosure;

FIG. 4A is a schematic illustration of an elevator ceiling panel access system in accordance with an embodiment of the present disclosure, with the ceiling panel shown in a closed state;

FIG. 4B is an illustration of the elevator ceiling panel access system of FIG. 4A shown in an open state;

FIG. 4C is an illustration of the elevator ceiling panel access system of FIG. 4A shown in a partially deployed state;

FIG. 4D is an illustration of the elevator ceiling panel access system of FIG. 4A shown in a deployed state;

FIG. 5A is a schematic illustration of a portion of an elevator ceiling panel access system in accordance with an embodiment of the present disclosure;

FIG. 5B is a schematic illustration of another portion of the elevator ceiling panel access system of FIG. 5A;

FIG. 6 is a schematic illustration of a portion of an elevator ceiling panel access system in accordance with an embodiment of the present disclosure, shown in a deployed state;

FIG. 7 is a schematic illustration of a portion of an elevator ceiling panel access system in accordance with an embodiment of the present disclosure, shown in a stowed state;

FIG. 8 is a schematic illustration of an elevator ceiling panel access system in accordance with an embodiment of the present disclosure, including a safety rail system;

FIG. 9 is a schematic illustration of an elevator and elevator ceiling access system in accordance with another embodiment of the present disclosure; and

FIG. 10 is a schematic illustration of an elevator and elevator ceiling access system in accordance with another embodiment of the present disclosure.

### DETAILED DESCRIPTION

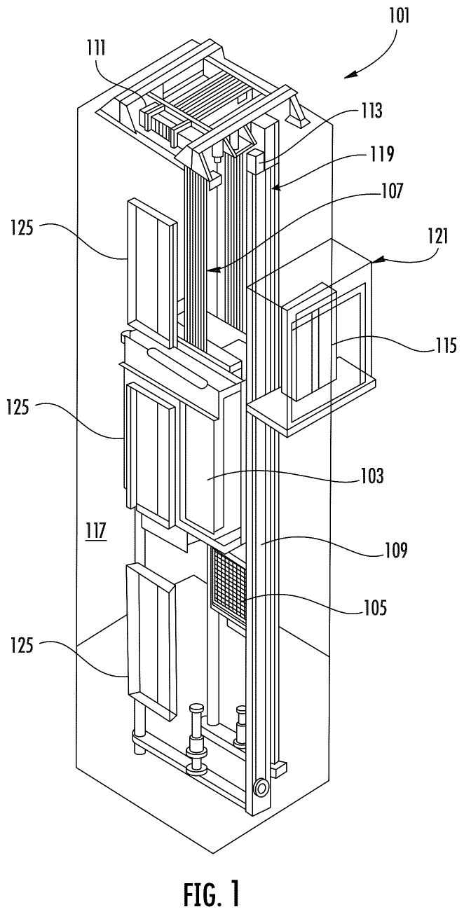

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which, in this illustrative embodiment, is part of an overhead structure of the elevator system 101, although other arrangements are possible without departing from the scope of the present disclosure. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown in the illustrative arrangement, in a controller room 121 of the elevator shaft 117 and is configured to control the operation of the elevator system 101, and particularly the elevator car 103. In other embodiments the controller 115 can be located in other locations, including, but not limited to, fixed to a landing or landing door or located in a cabinet at a landing. The elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

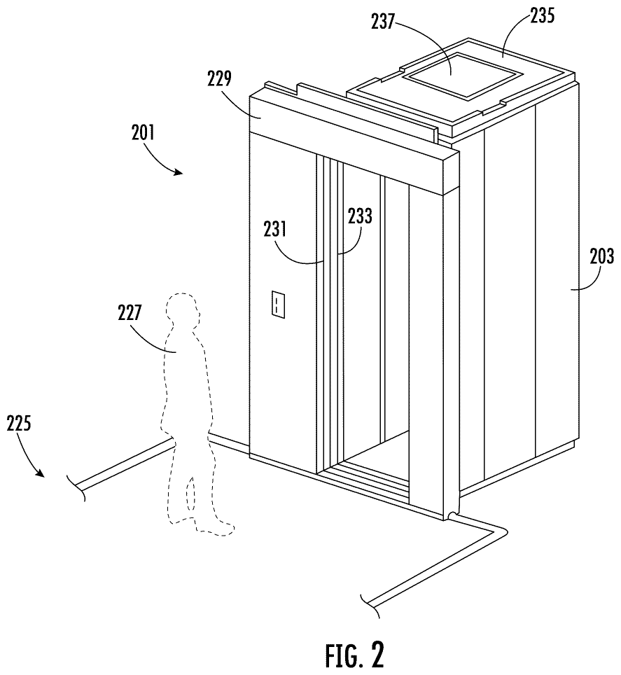

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a user 227 (e.g., passenger or mechanic) that desires to travel to another floor within a building or perform maintenance on a portion of the elevator system 201. A car door lintel 229 of the elevator system 201 can include a door opening system or door operator to enable opening and closing of car doors 231 and landing doors 233 when the elevator car 203 is located at the landing 225. At times, such as during maintenance operations, a mechanic 227 may need to access an elevator car top 235 through a ceiling access panel 237.

In conventional systems, the mechanic 227 may be required to bring a step ladder and/or other equipment into the elevator car 203, in order to perform maintenance through the ceiling access panel 237. This requires additional equipment to be carried by the mechanic. Embodiments provided herein are directed to improved systems for accessing, opening, and operating ceiling access panels and providing access to an elevator car top, such as for inspection and/or maintenance operations. In accordance with embodiments of the present disclosure, elevator ceiling access systems are described having platforms and ladders that are stowed at/on the elevator and improve ease of use, safety, access, and the like among other benefits, as will be appreciated by those of skill in the art.

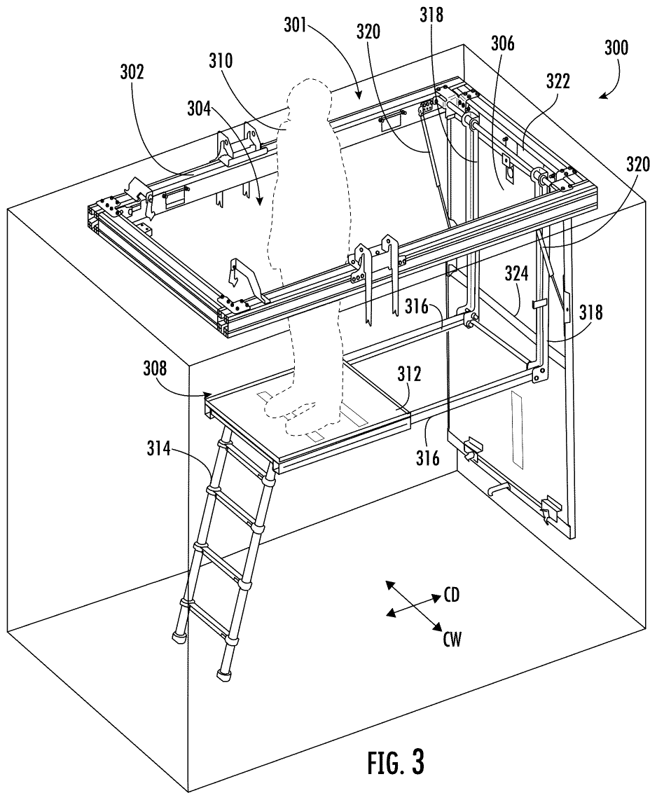

Referring now to FIG. 3, a schematic illustration of an elevator car 300 in accordance with an embodiment of the present disclosure is shown. The elevator car 300 includes a ceiling frame 302 that defines an opening 304 therein. The opening 304 may be selectively opened (e.g., as shown) and closed or sealed by a ceiling access panel 306. The ceiling access panel 306 is hingedly attached or connected to the ceiling frame 302, and is shown in an open state in FIG. 3. The elevator car 300 includes a ceiling panel access system 301 that includes a platform assembly 308 that may be used by a technician 310 to access the opening 304 in order to perform inspections, maintenance operations, and the like. The platform assembly 308 includes a platform 312, a ladder 314, and platform supports 316 that are configured to support the platform 312 at one end, as shown.

In accordance with embodiments of the present disclosure, the platform assembly 308 is attached to the ceiling access panel 306 such that the platform assembly 308 is stored and housed at/on the elevator car 300, thus eliminating the need for extra ladders or the like to be brought onsite and into the elevator car 300 when ceiling access is required. The ladder 314 may be hingedly or pivotably attached to the platform 312 or may be removably attached thereto, depending on the specific implementation thereof. The platform 312 is configured to pivot/rotate and slide/translate relative to the ceiling access panel 306 while being attached at an end of the platform 312. The platform supports 316 pivotably attach to respective mounting rails 318, which are movingly supported or attached to the ceiling access panel 306. The ceiling access panel 306 is supported on the ceiling frame 302 at one end or side of the ceiling access panel 306 and by one or more biasing elements 320 (e.g., gas springs, pistons, telescoping supports, etc.). The mounting rails 318 are movably attached at a first end to a first rail support 322 and at a second end to a second rail support 324. The first rail support 322 is attached to at least one of the ceiling frame 302 and the ceiling access panel 306 and the second rail support 324 is attached to the ceiling access panel 306.

The platform assembly 308 is configured to enable adjustment of position of the platform 312 within the elevator car 300. For example, the platform assembly 308 is configured to permit movement or adjusting of position of the platform 312 in both a car width (CW) direction and a car depth (CD) direction. For example, the mounting rails 318 are configured to travel along the first rail support 322 and/or the second rail support 324 in the car width (CW) direction. The mounting rails 318 may be secured to the first and second rail supports 322, 324 by locking elements, as described herein (e.g., locking pins, threaded knobs, etc.). As such, the platform 312 may be adjusted from side to side within the elevator car 300 by sliding the mounting rails 318 along the rails supports 322, 324 in the CW direction. When the platform 312 is moved into a desired position, the mounting rails 318 may be secured to, at least, the second rail support 324. The platform 312 may also be adjusted in the car depth (CD) direction by sliding the platform 312 along the platform supports 316. The platform 312 may be positioned and then secured in place to the platform supports 316 by respective locking elements (e.g., locking pins, threaded knobs, etc.).

As used herein, the term car depth direction (CD direction) is a direction from an elevator car door toward a back of the elevator car, and the car width direction (CW direction) is normal to the CD direction. It will be appreciated that other terms of direction may be used without altering the scope of the present disclosure. For example, the CD direction may be referred to as a first direction of adjustment or first adjustment direction and the CW direction may be referred to as a second direction of adjustment or second adjustment direction. It will further be appreciated that the CD direction is not limited to being the first direction, as the CW direction may be referred to as a first direction. However, it will be appreciated that the two directions are normal to each other.

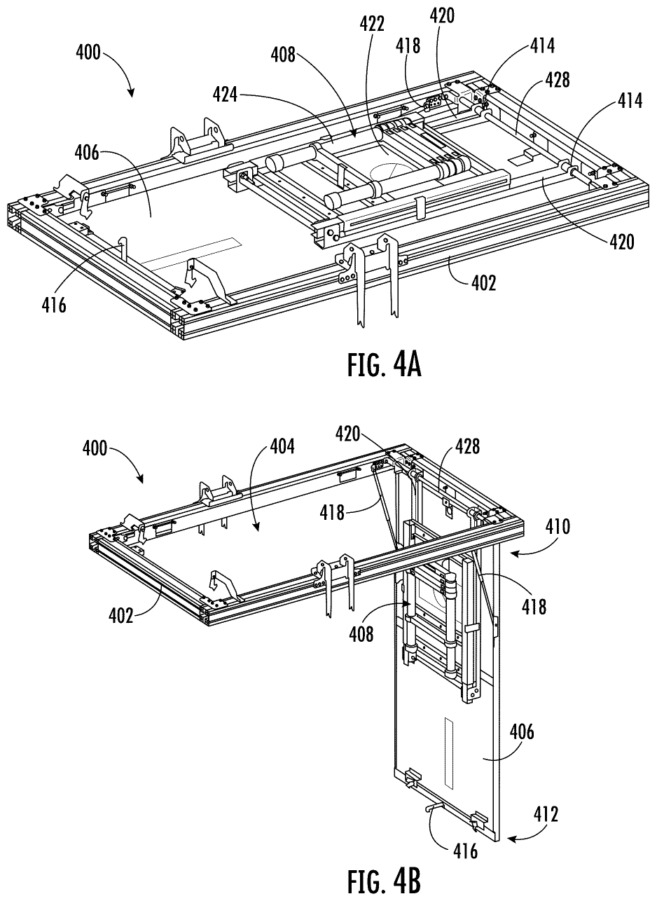

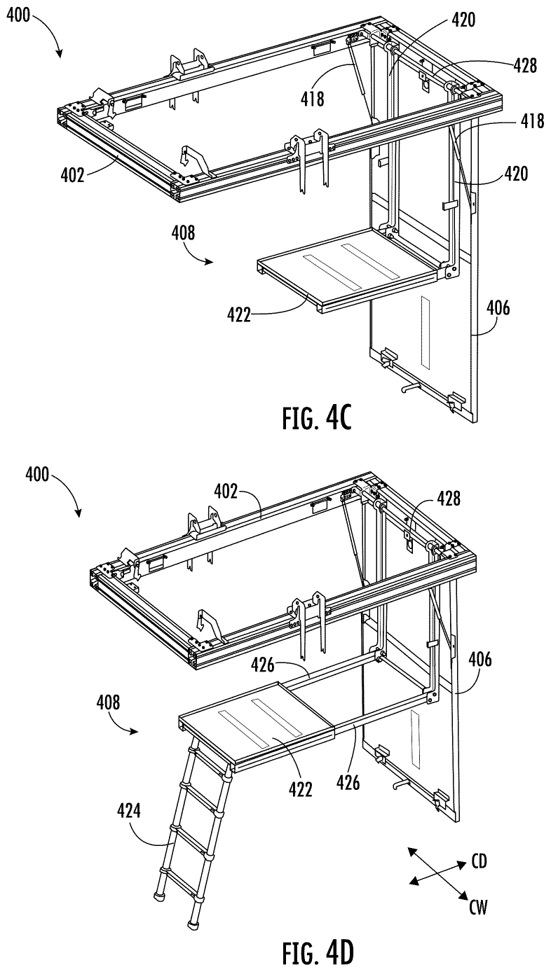

Referring now to FIGS. 4A-4D, schematic illustrations of operation of an elevator ceiling access system 400 for an elevator system in accordance with an embodiment of the present disclosure are shown. The elevator ceiling access system 400 may be installed on or part of an elevator car, for example as shown in FIG. 3. The elevator ceiling access system 400 includes a ceiling frame 402 that defines an opening 404 (FIG. 4B) which is selectively covered or closed by a ceiling panel 406. Removably attached or mounted to the ceiling panel 406 is a platform assembly 408. FIG. 4A illustrates the ceiling panel 406 and platform assembly 408 in a closed or stowed state and FIG. 4B illustrates the ceiling panel 406 and platform assembly 408 in an open state, with the platform assembly 408 still stowed or secured on the ceiling panel 406. FIGS. 4C-4D illustrate steps of deploying the platform assembly 408, and an illustration of a fully deployed platform assembly is shown and illustrated in FIG. 3, above.

Referring to FIG. 4A, in the stowed state, the ceiling panel 406 is closed and secured into a locked position relative to the ceiling frame 402. The locking of the ceiling panel 406 to the ceiling frame 402 may be by known conventional means, such as fasteners, detent pins, locking elements (e.g., triangular key), or the like, as will be appreciated by those of skill in the art. The ceiling panel 406 has a first end 410 and a second end 412 (see FIG. 4B). The first end 410 of the ceiling panel 406 is hingedly or pivotably attached to the ceiling frame 402 by one or more hinge elements 414. The second end 412 of the ceiling panel 406 is configured to selectively attach to a portion of the ceiling frame 402 and is releasable therefrom to allow for opening of the ceiling panel 406 and exposing the opening 404. For example, the second end 412 of the ceiling panel 406 may include a locking element 416, which may be actuated to unlock and release the attachment between the ceiling panel 406 and the ceiling frame 402. With the opening 404 (see FIG. 4B) exposed or opened, a user (e.g., mechanic) can access a top of the elevator car and gain access to the exterior of the elevator car through the top (e.g., elements within an elevator shaft or on top of the elevator car).

The ceiling panel 406 may be supported by one or more biasing elements 418, such as pistons, springs, or the like. The biasing elements 418 may be provided to aid in opening and closing the ceiling panel 406, such as the ease the lowering of the ceiling panel 406 from the closed state (FIG. 4A) to the open state (FIG. 4B), and/or for aiding closing of the ceiling panel from the open state to the closed state.

The platform assembly 408 is movably attached to the ceiling panel 406 on one or more mounting rails 420. The mounting rails 420 may be configured to provide support and hinged rotation of the ceiling panel 406 relative to the ceiling frame 402 while also supporting the platform assembly 408 thereon. The mounting rails 420 may be fixedly attached to the ceiling panel 406, such as by fasteners, welding, or the like. In other embodiments, the mounting rails 420 may be integrally formed with the ceiling panel 406. The platform assembly 408 may be secured or removably attached to the ceiling panel 406 by one or more securing elements, as described herein.

As shown in FIGS. 4A-4B, the ceiling panel 406 may be opened to expose the opening 404. In the open state of the ceiling panel 406, the platform assembly 408 is exposed and available to be accessed and used. FIGS. 4C-4D illustrate additional steps for deploying, accessing, and using the platform assembly 408. The platform assembly 408 includes a platform 422 and a ladder 424. When stowed, the ladder 424 is secured to the platform 422, which is secured as a complete assembly to the ceiling panel 406. As shown in FIG. 4C, the platform assembly 408 may be folded downward from the ceiling panel 406. In this orientation, the platform assembly 408 is attached to and supported by the mounting rails 420 on one side of the platform 422. That is, the platform 422 is hingedly mounted to the ceiling panel 406 at one end or side thereof. When the platform assembly 408 is folded down from the stowed position (FIG. 4B) to the partially deployed position (FIG. 4C), the platform assembly 408 is supported by the connection between the platform 422 and the mounting rails 420.

Once deployed in the partially deployed position (FIG. 4C), a user may then deploy the ladder 424. For example, the user may unlock or disconnect the ladder 424 from being secured to the platform 422. The ladder 424 may then be unfolded or otherwise deployed, as shown in FIG. 4D. The ladder 424 may be configured to secure to a bottom side of the platform 422 and may be hingedly or pivotably attached to the platform 422. The ladder 424 may be configured to provide stability and support to the platform 422 while also providing a means for climbing from a floor of an elevator car onto the platform 422. The ladder 424 may be adjustable in length/height. For example, the ladder 424 may be a telescoping or folding ladder that can be stowed in a collapsed state and deployed to various lengths/heights for use.

The platform 422 may be movable relative to the ceiling panel 406. The platform 422 may be movable relative to the ceiling panel 406 along one or more platform rails 426. For example, the platform 422 may be slidable along the platform rails 426 in a car depth (CD) direction relative to the ceiling panel 406. As such, the distance of the platform 422 relative to the ceiling panel 406 may be adjusted in the car depth (CD) direction along the platform rails 426. A second direction of movement or adjustment of the platform 422 may be provided along a sliding rail 428. For example, the mounting rails 420 may be slidingly mounted along the sliding rail 428 using one or more bushing configurations, slides, nested rails, wheels, rollers, or the like. Accordingly, the position of the platform 422 within an elevator car may be adjusted both in the car depth (CD) direction along the platform rails 426 and in the car width (CW) direction along the sliding rail 428.

In the deployed state (FIG. 4D), a user can adjust the position of the platform 422 to a desired location and thus access different regions or areas of the opening 404. The platform 422 is structurally supported by the platform rails 426 and the deployed ladder 424. Accordingly, a user may be able to stand on the platform 422 to perform inspections, maintenance, or the like.

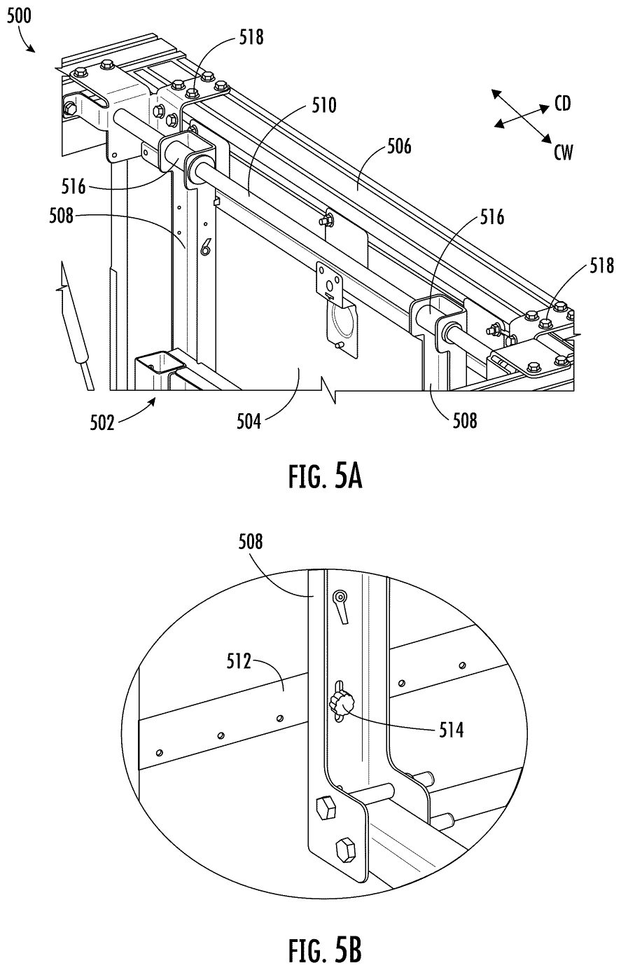

Referring now to FIGS. 5A-5B, schematic illustrations of a part of an elevator ceiling access system 500 in accordance with an embodiment of the present disclosure are shown. FIG. 5A is an enlarged detailed view of one type of connection for movably supporting a platform assembly 502 to a ceiling panel 504 and/or a ceiling frame 506. The platform assembly 502 may include a platform and ladder that are pivotably mounted to the ceiling panel 504 and/or to the ceiling frame 506. The platform assembly 502 is mounted along one or more mounting rails 508. The mounting rails 508 are movably attached to a sliding rail 510 at one end. At an opposite end of the mounting rails 508, the mounting rails 508 are selectively attachable to a support bracket 512, as shown in FIG. 5B. The mounting rails 508 may be selectively and removably attached to the support bracket 512 by a locking pin 514. The locking pin 514 may be a detent pin, threaded element (e.g., screw, bolt, threaded knob, etc.), biased element, or the like, which may be selectively actuated or selectively installed to secure the mounting rails 508 to the support bracket 512.

With the locking pin(s) 514 removed or decoupled from the support bracket 512, the mounting rails 508 may be moveable along the sliding rail 510. When the position of the platform assembly 502 is at a desired position, a user may then engage, install, couple, or otherwise secure the mounting rails 508 to the sliding rail 510 using the locking pin(s) 514. The mounting rails 508 slidingly attach to the sliding rail 510 at respective bushings 516. The bushings 516 are arranged to slide along the sliding rail 510. Although shown with a bushing configuration, it will be appreciated that the mounting rails of systems described herein may be movably in a car width (CW) direction by other mechanisms, including and without limitation, wheels, bearings, track assemblies, and the like. The sliding rail 510 is fixedly mounted to the ceiling frame 506 by one or more sliding rail support brackets 518. Accordingly, a user may be able to adjust the position of the platform of the platform assembly 502 in the car width (CW) direction. The position of the platform may be secured by the locking pin(s) 514 that are engaged with the support bracket 512.

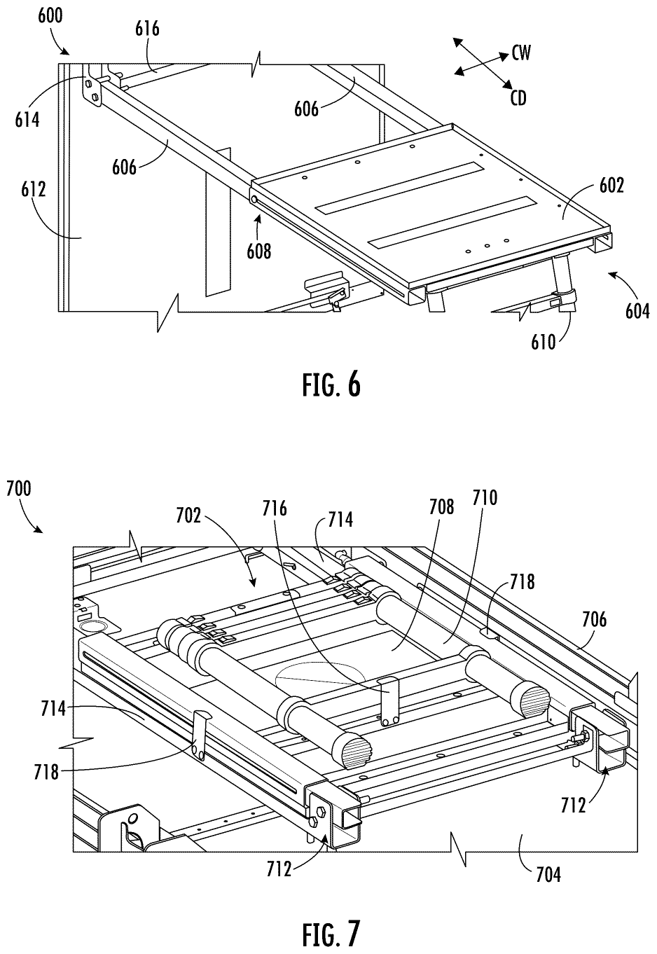

Referring to FIG. 6, a schematic illustration of a portion of a part of an elevator ceiling access system 600 in accordance with an embodiment of the present disclosure is shown. FIG. 6 is an enlarged detailed view of a platform 602 of a platform assembly 604 that is adjusted in the car depth (CD) direction. The platform 602 may also be adjustable in the car width (CW) direction, such as shown and described above. As shown, the platform assembly 604 includes the platform 602 which is movably supported on platform rails 606 which allows for the platform 602 to be moved in the car depth (CD) direction along the platform rails 606. The platform 602 may be configured with a sliding assembly 608. The sliding assembly 608 may be configured with one or more detents, pins, locking elements, or the like, which allow for the platform 602 to be selectively and removably secured to the platform rails 606. Also shown in FIG. 6, the platform assembly 604 includes a ladder 610 that is deployable from the platform 602. The platform assembly 604 is supported on a ceiling panel 612 by one or more mounting rails 614. The platform 602 may be adjustable in the car width (CW) direction along a support bracket 616. When deployed, and in accordance with various embodiments of the present disclosure, the platform 602 may be structurally supported by the ladder 610, the platform rails 606, the mounting rails 614, the ceiling panel 612, and/or combinations thereof.

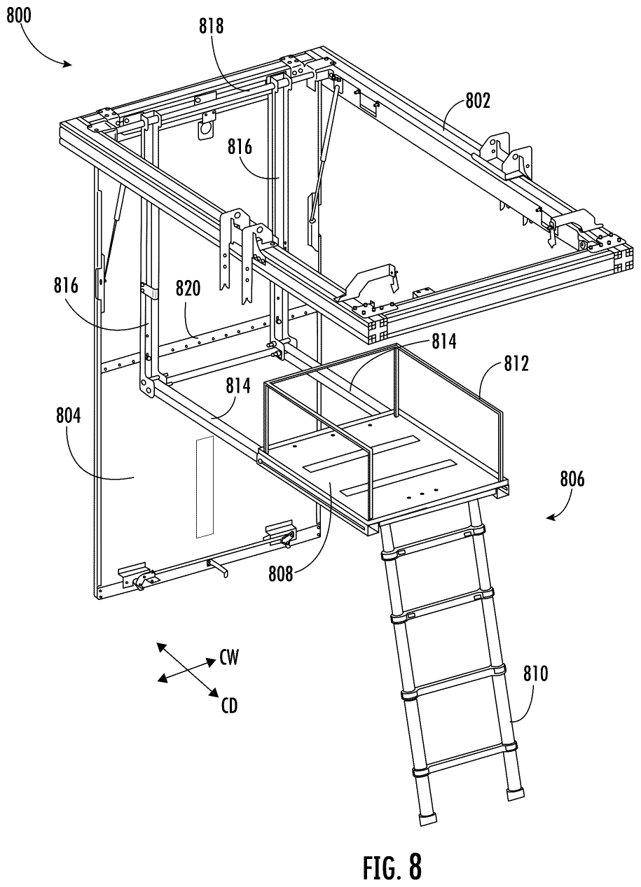

Referring to FIG. 7, a schematic illustration of a portion of a part of an elevator ceiling access system 700 in accordance with an embodiment of the present disclosure is shown. FIG. 7 is an enlarged detailed view of a platform assembly 702 that is removably attached to a ceiling panel 704 of an elevator car. In FIG. 7, the ceiling panel 704 is in the closed state (e.g., FIG. 4A) to a ceiling frame 706. The platform assembly 702 is secured in place. The platform assembly 702 includes a platform 708 and a ladder 710. The platform 708 is supported, in part, by pivot connection(s) 712 to one or more mounting rails 714. In the stowed or stored state, the ladder 710 is fixedly secured to the platform 708 by at least one ladder lock 716. The platform 708 is secured in place to the mounting rails 714 by respective platform locks 718. The locks 716, 718 may be tabs, rotating tabs, detent locks, detent pins, snap connections, threaded connections, fasteners, magnetic connections, or the like, that are able to be manipulated, operated, or actuated to allow selective release of the platform 708 from the mounting rails 714 and selective release of the ladder 710.

Referring now to FIG. 8, a schematic illustration of an elevator ceiling access system 800 in accordance with an embodiment of the present disclosure is shown. The elevator ceiling access system 800 may be similar to that shown and described above, and thus like features may not be described again. As shown in FIG. 8, the elevator ceiling access system 800 includes a ceiling frame 802 that is part of an elevator car. A ceiling panel 804 is configured to open and close relative to the ceiling frame 802 and is pivotably or rotationally mounted to the ceiling frame 802. A platform assembly 806 is provided on the ceiling panel 804 and is movably attached thereto. The platform assembly 806, as shown in FIG. 8, includes a platform 808 and a ladder 810. In this illustrative embodiment, the platform assembly 806 includes a safety rail system 812. The safety rail system 812 may be a set of collapsible or removably attachable rails that can be arranged about a perimeter of the platform 808. The safety rail system 812 may be used to provide safety to a user of the platform assembly 806. The safety rail system 812 may be configured to be fixedly attached to the platform 808 and provide a stop or edge rail to prevent a user from falling off the platform 808 or making a misstep or the like. In some embodiments, the rails of the safety rail system 812 may be telescoping poles, in other configurations, the poles/rails of the safety rail system 812 may be collapsible or foldable to be stowed on/to the platform 808, similar to the stowing of the ladder 810 to the platform 808, such as shown in FIG. 7.

FIG. 8 also illustrates a position of the platform 808 in a use state. The platform 808 is deployed and folded down from the ceiling panel 804. The platform 808 is supported at one end by platform rails 814 and mounting rails 816. The platform rails 814 support the platform 808 at one end or side and allow for adjustment of the position of the platform 808 in a car depth (CD) direction. At the opposite end or side from the platform rails 814, the platform 808 is supported by the ladder 810, which is shown in a deployed state. The platform 808 is also adjustable in a car width (CW) direction, as described above, with the mounting rails 816 being movable along a sliding rail 818 and selectively engageable with a support bracket 820.

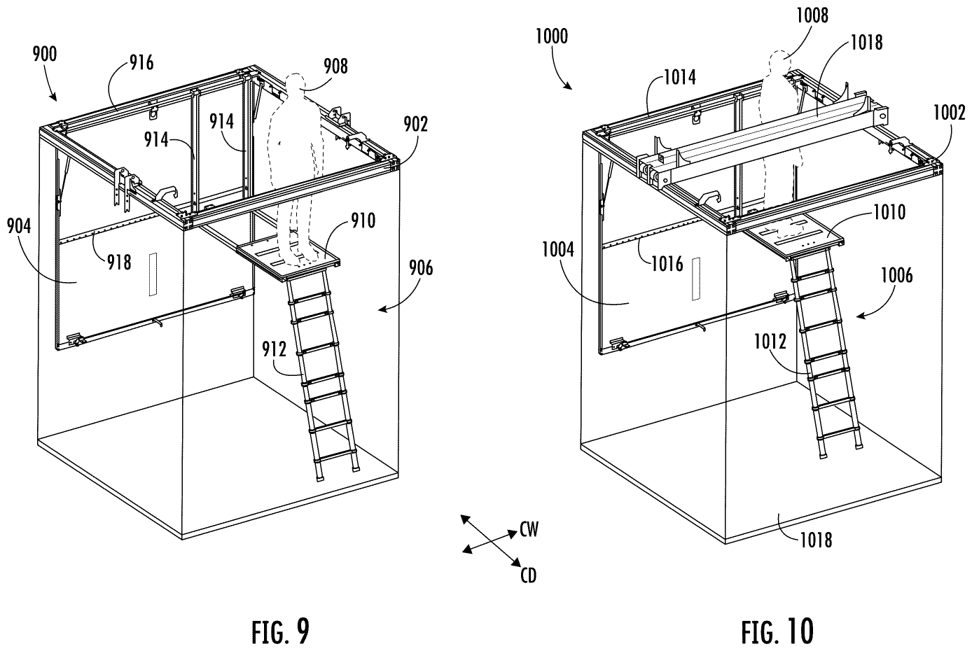

Referring now to FIG. 9, a schematic illustration of an elevator car 900 in accordance with an embodiment of the present disclosure is shown. The elevator car 900 includes a ceiling frame 902 that defines an opening therein. The opening may be selectively opened (e.g., as shown) and closed or sealed by a ceiling panel 904. The ceiling panel 904 is hingedly attached or connected to the ceiling frame 902, and is shown in an open state in FIG. 9. The elevator car 900 includes a platform assembly 906 that may be used by a technician 908 to access the opening in order to perform inspections, maintenance operations, and the like. The platform assembly 906 includes a platform 910 and a ladder 912. In the illustration of FIG. 9, the platform assembly 906 has been deployed from the ceiling panel 904, and the platform 910 is extended from mounting rails 914 that are attached to or part of the ceiling panel 904. The platform assembly 906 may be adjustable and fixable in various positions within an elevator car (CW and CD directions).

As shown in FIG. 9, the platform 910 is moved away from the ceiling panel 904 in the CD direction by a separation distance. Furthermore, the position in the CW direction may be adjusted along a sliding rail 916 to allow for the technician 908 to position the platform 910 in a desired location within the elevator car 900. When the technician 908 positions the platform 910 in a desired location, the platform 910 may be secured in place by securing the mounting rails 914 to a support bracket 918.

It will be appreciated that the opening defined by the ceiling frame 902 of FIG. 9 is relatively larger than the illustrative configurations shown above. Because the platform 910 can be moved by the mechanic 908 (e.g., in both the CD and CW directions), the elevator ceiling access systems described herein may be used in any size/dimension elevator car while allowing for the mechanic 908 to access any of the sides of the opening defined by the ceiling frame 902.

Referring now to FIG. 10, a schematic illustration of an elevator car 1000 in accordance with an embodiment of the present disclosure is shown. The elevator car 1000 includes a ceiling frame 1002 that defines an opening therein. The opening may be selectively opened (e.g., as shown) and closed or sealed by a ceiling panel 1004. The ceiling panel 1004 is hingedly attached or connected to the ceiling frame 1002, and is shown in an open state in FIG. 10. The elevator car 1000 includes a platform assembly 1006 that may be used by a technician 1008 to access the opening in order to perform inspections, maintenance operations, and the like. The platform assembly 1006 includes a platform 1010 and a ladder 1012. In the illustration of FIG. 10, the platform assembly 1006 has been moved along a sliding rail 1014 and a support bracket 1016 in a car width (CW) direction.

Similar to the configuration of FIG. 9, the opening defined by the ceiling frame 1002 in FIG. 10 is relatively larger than the illustrative configurations shown above. In this configuration, the elevator car 1000 is an overslung configuration having a structural frame element 1020 spanning the opening defined by the ceiling frame 1002. Even with such blockage of the opening by the structural frame element 1020, because the platform assembly 1006 can be moved around by the mechanic 1008, access to any of the sides of the opening defined by the ceiling frame 1002 and/or around the structural frame element 1020 may be achieved.

Advantageously, embodiments of the present disclosure are directed to elevator ceiling access systems that provide benefits over current solutions. For example, in accordance with some embodiments, the need for a mechanic to bring a ladder to an elevator is eliminated, as the ladder and platform systems of the present disclosure may be stored on/at the elevator car to be serviced. Further, advantageously, embodiments of the present disclosure can reduce or eliminate wear or damage that may be caused to the elevator car due to additional tools and equipment being brought to the elevator car. Furthermore, the platform assemblies described herein may be used by any user/mechanic, because the platform system is provided at the elevator car, and may be sized and moved/adjusted to accommodate access to the ceiling, the top of the car, or the like. Additionally, embodiments of the present disclosure do not require any special or specific tools or equipment to operate. For example, opening and closing of the ceiling panel may be assisted by biasing elements (e.g., pistons, springs, etc.). Furthermore, advantageously, the elevator ceiling access systems described herein may be used in both overslung and underslung roping elevator configurations.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator ceiling access system comprising:
a ceiling panel of an elevator car; and
a platform assembly movably attached to the ceiling panel, the platform assembly comprising a platform and a ladder that is deployable from the platform,
wherein the platform assembly is deployable from a stowed state to a deployed state, wherein in the deployed state a position of the platform is adjustable within the elevator car and the platform is supported on one side by the ladder and on an opposite side by the ceiling panel.

2. The elevator ceiling access system of claim 1, further comprising a ceiling frame, wherein the ceiling panel is pivotably mounted to the ceiling frame.

3. The elevator ceiling access system of claim 2, further comprising a locking element configured to releasably secure the ceiling panel to the ceiling frame.

4. The elevator ceiling access system of claim 2, further comprising at least one biasing element configured to support and connect the ceiling panel to the ceiling frame.

5. The elevator ceiling access system of claim 2, wherein the ceiling panel is hingedly or pivotably attached to the ceiling frame by one or more hinge elements.

6. The elevator ceiling access system of claim 1, further comprising at least one mounting rail configured as part of or attached to the ceiling panel, wherein the platform assembly is supported on the at least one mounting rail in the stowed state and in the deployed state.

7. The elevator ceiling access system of claim 6, wherein the platform assembly comprises at least one platform rail that pivotably connects to the at least one mounting rail.

8. The elevator ceiling access system of claim 6, wherein the at least one mounting rail is pivotably connected to the platform at one end of the at least one mounting rail and an opposite end of the at least one mounting rail is slidingly mounted on a sliding rail.

9. The elevator ceiling access system of claim 8, further comprising a support bracket arranged on the ceiling panel, wherein the at least one mounting rail is configured to selectively attach to the support bracket.

10. The elevator ceiling access system of claim 1, wherein the platform assembly further comprises a safety rail system that is configured to attach to the platform.

11. The elevator ceiling access system of claim 10, wherein the safety rail system comprises collapsible elements configured to be stored on the platform assembly when the platform assembly is in the stowed state.

12. The elevator ceiling access system of claim 1, wherein the ladder is hingedly attached to the platform.

13. The elevator ceiling access system of claim 1, wherein the platform is adjustable in a first direction along one or more platform rails and adjustable in a second direction along a sliding rail, wherein the first direction and the second direction are normal to each other.

14. The elevator ceiling access system of claim 1, wherein the platform assembly is configured to be unfolded from the stowed state to the deployed state from the ceiling panel.

15. The elevator ceiling access system of claim 1, wherein the ladder is releasably secured to the platform by a ladder lock.

16. The elevator ceiling access system of claim 1, wherein the platform assembly is releasably secured to the ceiling panel by at least one platform lock.

17. The elevator ceiling access system of claim 1, wherein the ladder is one of a collapsible ladder and a telescoping ladder.

18. An elevator system comprising:
an elevator car having a floor, a ceiling, and side walls defining an interior of the elevator car;
a ceiling frame defining an opening in the ceiling of the elevator car;
a ceiling panel arranged to cover the opening and configured to be opened to expose the opening; and
a platform assembly movably attached to the ceiling panel, the platform assembly comprising a platform and a ladder that is deployable from the platform, wherein the platform assembly is deployable from a stowed state to a deployed state, wherein in the deployed state a position of the platform is adjustable within the elevator car and the platform is supported on one side by the ladder and on an opposite side by the ceiling panel.

19. The elevator system of claim 18, wherein the elevator car is an overslung elevator car.

20. The elevator system of claim 18, wherein the platform, when in the deployed state, is adjustable in a car width direction and a car depth direction while being supported on one or more mounting rails.
